(19) United States
(12) Patent Application Publication
(10) Pub. No.: US 2007/0076074 A1
(43) Pub. Date: Apr. 5, 2007

(54) Method and apparatus for print medium determination

(75) Inventors: Hongsheng Zhang, San Diego, CA (US); Christopher G. Wykoff, San Diego, CA (US); David A. Poirier, Escondido, CA (US); Gerald M. Brown, San Diego, CA (US); James A. Mott, San Diego, CA (US); William E. Bland, Cardiff-by-the Sea, CA (US); Chris T. Armijo, San Diego, CA (US)

Correspondence Address: Mark G. Bocchetti;Patent Legal Staff, Eastman Kodak Company, 343 State Street, Rochester, NY, 14650-2201, US

(73) Assignee: Eastman Kodak Company

(21) Appl. No.: 11/243,643

(22) Filed: Oct. 5, 2005

(51) Int. Cl. B41J 2/01

(52) U.S. Cl. 347/101

(57) ABSTRACT

A printer and a method are provided for determining a type of print medium in a printer. The method comprises the steps of: obtaining a first set of reflectance data from a first side of the print medium; obtaining a second set of reflectance data from a second side of the print medium; comparing the first set of reflectance data to the second set of reflectance data; and categorizing the print medium as being in one of a plurality of print medium categories based upon the comparison of the first set of reflectance data and second set of reflection data.

### FIELD OF THE INVENTION

The present invention is related to printers and to methods for determining a type of print medium loaded therein.

### BACKGROUND OF THE INVENTION

There are a wide variety of items upon which images can be printed by modem printers such as papers, films, transparencies, packaging materials, solid objects, and the like. Even within relatively focused use printers such as home and office printers that typically print only on relatively flat papers or transparencies there is an increasingly bewildering assortment of available print mediums such as a wide variety of colored papers, white papers, transparencies and photo papers. To ensure that a printer can print in a manner that yields a desired level of quality, it is useful to adapt the printing process to conform to the print medium that is to be used in the printing process.

Accordingly it is highly advantageous to determine a print medium type before printing. Generally, two types of approaches have been developed for doing this. A first approach for doing this is to provide data with the print medium that is to be read by a separate reader in the printer. Such data can be provided the form of visible or invisible markings on the medium. Such data can also be provided in the form of a mechanical, electromechanical or electronic memory device that stores information identifying the print medium that can be read to provide a medium type. Such markings or memories can be stored on the medium itself or on packaging associated with the medium. These approaches while highly useful can add cost to both the printer and to the medium.

A second approach seeks to avoid the costs of providing data with the medium by supplying equipment in a printer to determine a print medium type based upon analysis of a non-marked print medium prior to its use in printing. One example of this approach can be found in U.S. Pat. No. 6,561,643 entitled Advanced Media Determining System for Inkjet Printing, filed by Walker et al. The '643 patent provides a system that is said to be capable of categorizing a type of incoming media entering an inkjet or other printing mechanism to identify the media without requiring any special manufacturer markings.

In '643 patent, the leading edge of the incoming media is optically scanned using a blue-violet light to obtain both diffuse and specular reflectance values. A Fourier transform of these reflectance values generates a spatial frequency signature for the incoming media. The spatial frequency is compared with known values for different types of media to categorize the incoming media according to major categories, such as transparencies, glossy photo media, premium paper and plain paper, as well as specific types of media within these categories, such as matte photo premium media and high-gloss photo media. An optimum print mode is selected according to the determined media type to automatically generate outstanding images without unnecessary user intervention. A printing mechanism constructed to implement this method is also provided. Such a mechanism is complicated and costly as it requires the measurement of both specular and diffuse reflection, complex statistical analysis of the same in real time and an accurate library of signatures of particular print mediums. And it is still very difficult for such a system to discriminate certain media types such as colored plain paper vs. photo paper.

What is needed in the art is a system that enables, at low cost, simple detection of a print medium type without requiring frequency specific light detection or analysis of the reflectance data.

### SUMMARY OF THE INVENTION

In one aspect of the invention, a method of determining a type of print medium in a printer is provided. The method comprises the steps of: obtaining a first set of reflectance data from a first side of the print medium; obtaining a second set of reflectance data from a second side of the print medium; comparing the first set of reflectance data to the second set of reflectance data; and categorizing the print medium as being in one of a plurality of print medium categories based upon the comparison of the first set of reflectance data and second set of reflection data.

In another aspect of the invention, a printer comprises: a medium transport for conveying a print medium from a supply to a printing area; a printhead at the print area for forming an image using a print medium; a first reflectance sensor positioned in the medium transport path to confront the print medium before the print medium is conveyed to the print area, the first reflectance sensor having a first light source adapted to supply light to a first side of the print medium and a first detector adapted to generate a first reflectance signal that is indicative of an amount of the supplied light that is reflectively returned to the first detector; a second reflectance sensor positioned in the medium transport path to confront the print medium before the print medium is conveyed to the print area, the first reflectance sensor having a second light source adapted to supply light to a rear side of the print medium and a second detector adapted to generate a second reflectance signal that is indicative of an amount of the supplied light that is reflectively returned to the second detector; and a controller for causing the medium transport to transport the print medium to the printing area, for causing the first light source to supply light to the first side of the print medium and to detect the amount of the supplied light that is reflectively returned thereto, for causing the second light source to supply light to the back side of the print medium and to detect the amount of the supplied light that is reflectively returned thereto; the controller further being adapted to receive the first reflectance signal and the second reflectance signal and to determine a category for the print medium from a plurality of categories based upon a comparison of the reflectance of the first side of the print medium and the second side of the print medium as indicated by the first reflectance signal and the second reflectance signal.

In yet another aspect of the invention, a printer comprises: a medium transport for moving a print medium through a medium transport path to a printing area; a first light source and first detector positioned on a first side of the medium transport path for collecting a first set of reflectance data from a first side of the print medium; a second light source and a second detector positioned on a second side of the medium transport path for collecting a second set of reflectance data from a second side of the print medium; and wherein a controller causes the first and second sets of reflectance data to be collected prior to a point where a print medium in the print medium transport path is moved to the printing area.

### BRIEF DESCRIPTION OF THE DRAWINGS

FIG. 1 shows a first embodiment of a printer of the invention;

FIG. 2 provides a flow diagram showing one embodiment of a method for operating the printer of FIG. 1;

FIG. 3 is an illustration of an example distribution of first side reflectance values of an image receiving side of a hypothetical set of possible print mediums;

FIG. 4 is an illustration of an example distribution of first side reflectance values and second side reflectance values of a hypothetical set of possible print mediums;

FIG. 5 is an illustration of an example distribution of the differences between the first sides of each print medium of the hypothetical set of possible print mediums;

FIG. 6 is an illustration of first side reflectance values of an image receiving side of a low differential category of print mediums within the hypothetical set of possible print mediums;

FIG. 7 is an illustration of first side reflectance values of an image receiving side of a high differential category of print mediums within the hypothetical set of possible print mediums;

FIG. 8 illustrates one possible arrangement of reflectance sensor that can be used in the present invention and in which a common light source provides light to both of a first side reflecting mirror and a second side reflecting mirror which in turn direct a portion of this light as first side source light onto first side and a portion of this light as second side source light onto second side respectively of receiver medium;

FIG. 9 illustrates another possible arrangement of reflectance sensor that can be used in the present invention;

FIG. 10 illustrates another possible arrangement of a reflectance sensor that can be used in the present invention; and

FIG. 11 illustrates still another possible arrangement of a reflectance sensor that can be used in the present invention.

### DETAILED DESCRIPTION OF THE INVENTION

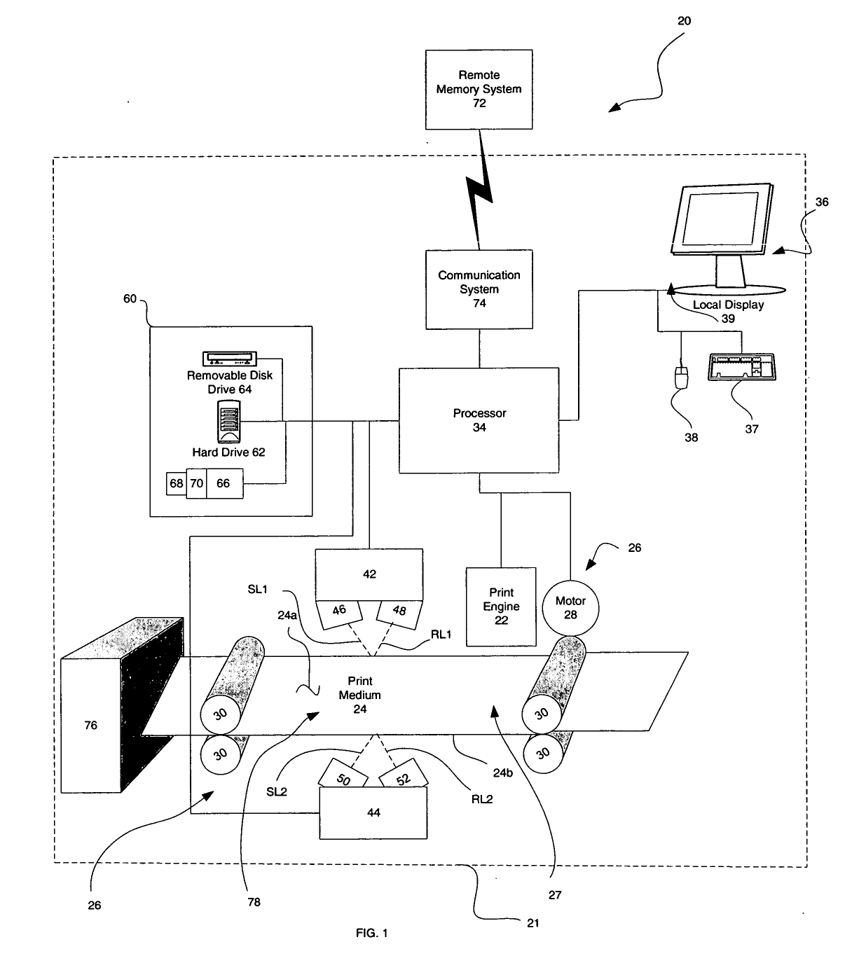

FIG. 1 shows a first embodiment of a printer 20 of the invention. In the embodiment of FIG. 1, printer 20 comprises a housing 21 having a print engine 22 that applies markings or otherwise forms an image on a print medium 24. Print engine 22 can record images on print medium 24 using a variety of known technologies including, but not limited to, conventional four color offset separation printing or other contact printing, silk screening, dry electrophotography such as is used in the NexPress 2100 printer sold by Eastman Kodak Company, Rochester, New York, USA, thermal printing technology, drop on demand ink jet technology and continuous inkjet technology. For the purpose of the following discussions, print engine 22 will be described as being of a type that generates color images. However, it will be appreciated that this is not necessary and that the claimed methods and apparatuses that are described herein can be practiced with a print engine 22 that is adapted to form monotone images such as black and white, grayscale or sepia toned images. Similarly, the methods and apparatuses that are described herein can be practiced with a print engine 22 that is adapted to deliver images in the form of a pattern of one or more functional materials on print medium 24. Examples of such functional materials include but are not limited to electrically conductive, insulating, semi-conductive or resistant materials of a type that can be used in combination to form electrical circuits and the like, optical materials of a type that are adapted for form optical conductors, reflectors, lenses and pathways. Other examples of functional materials include polymers, ceramics, metals and other such functional materials that can be used to form mechanical structures using print medium 24 as a support.

Print medium 24 can take any of a wide variety of forms including but not limited to a plain paper, photo-paper, non-photo paper, glossy paper, glossy paper, matte paper, transparency, translucent film, transparent film, packaging material, ceramic product, wood product, metal product, fabric, or a glass or glass fiber product, a polymer product, a mono-mer product or any other flexible, rigid or other material of a type that can cooperate with print engine 22 and a medium advance 26 so that an image can be recorded thereon. The image formed thereon can be of a type that is intended for viewing, a type that is machine readable or type that comprises a functional pattern of functional material such as an optical or electrical circuit or any combinations of such images.

Medium advance 26 is used to position print medium 24 and/or print engine 22 relative to each other to facilitate recording of an image on print medium 24. In the embodiment illustrated in FIG. 1, medium advance 26 moves print medium 24 through a printing area 27 so that print engine 22 can print an image on print medium 24. Medium advance 26 can comprise any number of well-known systems for moving receiver medium 24 within printer 20, including a motor 28, driving pinch rollers 30, a motorized platen roller (not shown) or other well-known systems for the movement of paper or other types of print medium 24.

Print engine 22 and medium advance 26 are operated by a processor 34. Processor 34 can include, but is not limited to, a programmable digital computer, a programmable microprocessor, a programmable logic processor, a series of electronic circuits, a series of electronic circuits reduced to the form of an integrated circuit, or a series of discrete components. Processor 34 operates printer 20 based upon input signals from a user input system 36, sensors 40, a memory 60 and a communication system 74.

User input system 36 can comprise any form of transducer or other device capable of receiving an input from a user and converting this input into a form that can be used by processor 34. For example, user input system 36 can comprise a touch screen input, a touch pad input, a 4-way switch, a 6-way switch, an 8-way switch, a stylus system, a trackball system, a joystick system, a voice recognition system, a gesture recognition system or other such systems. In the embodiment illustrated in FIG. 1, user input system 36 includes a keypad 37 and mouse 38 for receiving input from a user. A display 39 is connected to processor 34 and provides information to a user so that the user can interact with printer 20. Various components of user input system 36 and/or display 39 can be located within housing 21 or can be separate therefrom. Where separate, user input system 36 and display 39 can exchange signals with processor 34 by way of wired or wireless signals and connections.

Sensors 40 are provided in printer 20 to sense environmental, operating and other conditions relevant to the operation of printer 20 and to convert this information into a form that can be used by processor 34 in governing operation of print engine 22, and/or other systems of printer 20. Sensors 40 can include audio sensors adapted to capture sounds. Sensors 40 can also include print medium positioning sensors (not shown) and other sensors used internally to control printer operations.

Sensors 40 also include a first side reflectance sensor 42 and a second side reflectance sensor 44. Generally, reflectance sensors 42 and 44 can comprise any combination of visible or non-visible light sources known in the art that can be used to supply light and any light detectors known in the art that can sense an amount of the light from the light sources that is reflectively returned to the detectors.

It will be appreciated that first side light detector 48 and second side light detector 52 can be arranged to measure either specular reflectance or diffuse reflectance and/or both specular and diffuse reflectance. Specular reflectance is generally referred to herein as an amount of source light that is applied to a surface at an angle of incidence and that is reflected by the print medium at an angle that is generally equal to the angle of incidence, however, it will be appreciated that there are a number of generally accepted variations of the definition of specular reflectance known in the art for particular applications and that there are a variety methods for measuring specular reflectance, any of which can be used in determining the specular reflectance of the print medium 24. Diffuse reflectance is generally referred to herein as a measure of an amount of light reflected by a surface in a broad range of directions and in that sense can be considered to be a measure of the light scattering properties of a surface such as first side 24a of print medium 24. Here too, there are a number of generally accepted definitions of diffuse reflectance known in the art for particular applications and that there are a variety methods for measuring diffuse reflectance, any of which can be used in determining the diffuse reflectance of print medium 24.

In the embodiment shown in FIG. 1, first side reflectance sensor 42 has a first side light source 46 that directs first side source light SL1 at first side 24a of receiver medium 24 and a first side light detector 48 that receives first side reflected light RL1 comprising that portion of source light SL1 that is reflected by first side 24a. Similarly, second side reflectance sensor 44 has a second side light source 50 that directs second side source light SL2 onto a second side 24b of receiver medium 24 and a second side light detector 52 that receives second side reflected light RL2 comprising that portion of second side source light SL2 that is reflected by second side 24b.

The angular relationships between first side light source 46 and first side light detector 48, between second side light source 50 and second side light detector 52 shown in FIG. 1 are exemplary only and a wide variety of other arrangements can be used so long as the desired type of reflectance of each side of print medium 24 can be measured with a degree of accuracy necessary for repeatable measurements. In this exemplary example, first side light detector 48 and second side light detector 52 are arranged to receive light that is reflected by first side 24a of print medium 24 and second side 24b of print medium 24 at an angle that is equal to an angle of incidence of first side source light SL1 and second side source light SL2, respectively. Accordingly, in this example embodiment, first side light detector 48 and second side light detector 52 are positioned so that they can provide a meaningful indication of the specular reflectance of first side 24a and second side 24b of print medium 24, respectively.

First side light source 46 and second side light source 50 can comprise any of a number of light sources including but not limited to one or more of a light emitting diode, a laser, a laser diode, a monochromatic light source, or a polychromatic light source. The light emitted can be in the visible or non-visible wavelengths or a combination thereof In certain embodiments, at least one of the first side light source 46 and second side light source 50 has two or more light sources wherein the lights sources have different optical properties such as emitting light of different wavelengths. In such an embodiment, first side light detector 48 or second side light detector 52 can be capable of detecting light of each of the wavelengths, or a set of more than one detector can be provided so that a range of wavelengths of reflected light can be detected. In another embodiment, some of which are shown in greater detail below, at least one of the first side light source 46 and second side light source 50 can contain two or more light sources with the light sources being arranged to have a different orientation so that they apply source light to print medium 24 at different angles of incidence.

As shown in the embodiment of FIG. 1, print medium 24 is a paper type material that is moved from a print medium storage area 76 to printing area 27. Such a print medium 24 of this type can comprise any of a number of different types of print mediums 24. For example, a commercial or home printer of a type that uses paper type print mediums 24 are often called upon to print using any of a number of types of such print medium 24 such as plain paper, colored paper, matte finish paper, a gloss paper, and transparencies. Each of these different types of print medium 24 forms images or other patterns having highly desirable characteristics when processor 34 causes print engine 22 to print in a manner that is adapted for use with such a print medium 24. As will be described in greater detail below, processor 34 is adapted to determine a print medium type based upon the signals from sensors 40.

As is also shown in FIG. 1, printer 20 has a memory 60. Memory 60 can include conventional memory devices including solid state, magnetic, optical or other data storage devices. Memory 60 can be fixed within printer 20 or it can be removable. In the embodiment of FIG. 1, memory 60 is shown having a hard drive 62, a disk drive 64 for a removable disk such as an optical, magnetic or other disk memory (not shown) and a memory card slot 66 that holds a removable memory 68 such as a removable memory card and has a removable memory interface 70 for communicating with removable memory 68. Data including but not limited to control programs, digital images and metadata can also be stored in a remote memory system 72.

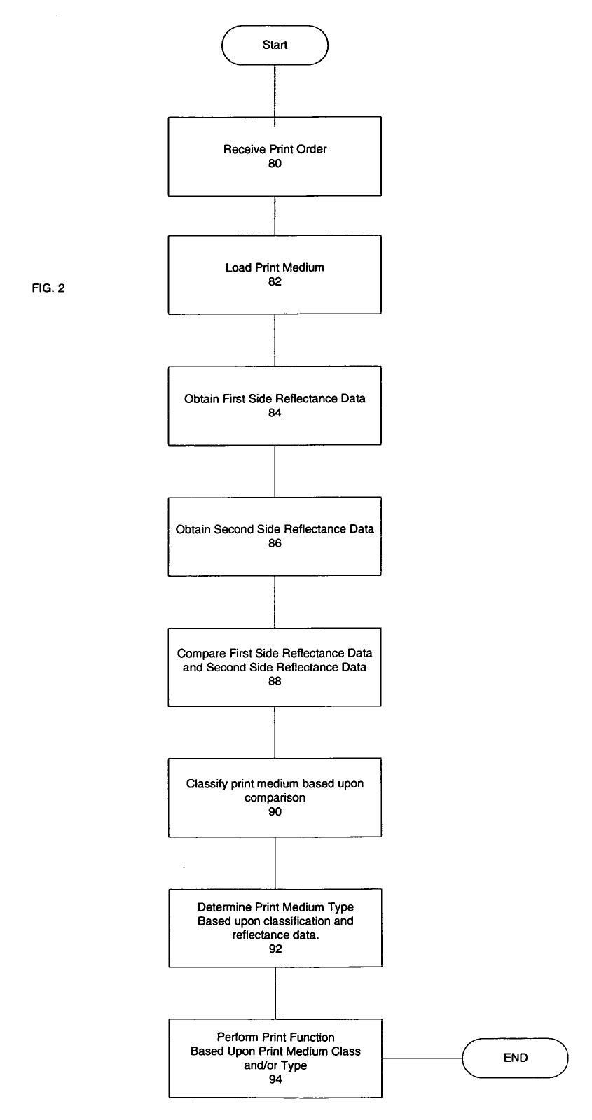

In the embodiment shown in FIGS. 1 and 2, printer 20 has a communication system 74 for communicating with, for example, remote memory system 72. Communication system 74 can be for example, an optical, radio frequency circuit having a transducer and appropriate signal processing circuitry to convert image and other data into a form that can be conveyed to a remote device such as remote memory system 72 by way of an optical signal, radio frequency signal or other form of signal. Communication system 74 can also be used to receive a digital image and other information from a host computer or network (not shown). Communication system 74 provides processor 34 with information and instructions from signals received thereby.

FIG. 2 provides a flow diagram showing one embodiment of a method for operating printer 20 of FIG. 1. As is shown in the embodiment of FIG. 2, a print order is received by printer 20 (step 80). The print order provides instructions sufficient for processor 34 to begin a print sequence and can include an instruction to print an image, the image data for the image to be printed, print quantity information or information identifying a selected print medium 24 upon which the image is to be printed. The print order can also contain other information including but not limited to as delivery date, delivery destination information, consumer information, and point of sale information.

Processor 34 can receive a print order in a variety of ways including but not limited to a receiving entries made at user input system 36, receiving signals received at communication system 64, or in response to data provided by way of memory 50 including but not limited to data provided by way of a removable memory card 68.

As shown in FIG. 2, when processor 34 receives the print order, processor 34, initiates a print medium loading process (step 82). During the print medium loading process (step 82) processor 34 sends signals causing medium advance 26 to move a print medium 24 from a storage location 76 to a printing area 27. In the embodiment illustrated in FIG. 1, print medium 24 is passed through a scanning area 78 as it is moved from a storage location 76 to printing area 27. First side reflectance sensor 42 and second side reflectance sensor 44 are arranged so that reflectance data can be obtained and processed while print medium 24 is advanced through scanning area 78. In other embodiments, scanning area 78 can be located at printing area 27.

A set of first side reflectance data is obtained from a first side of the print medium (step 84) using first side reflectance sensor 42. In the embodiment of FIG. 1, processor 34 generates a first side illumination signal that cause first side light source 46 to radiate first side source light SL1 having a known intensity and/or wavelength at a time when print medium 24 is positioned in scanning area 78. First side light detector 48 receives first side reflected light RL1, generates a first intensity signal which indicating an intensity of first side reflected light RL1. The first intensity signal is received by processor 34. Processor 34 uses the first intensity signal to determine a first set of reflectance data. In one embodiment, the absolute value of the first intensity signal or an intensity of the first side reflected light determined therefrom is used to form the first set of reflectance data. In other embodiments, the intensity of the first side reflected light RL1 indicated by the first intensity signal is compared to a known intensity or range of intensities of the first side source light SL1 to determine a first set of reflectance data.

The first set of reflectance data can comprise a single data point or a plurality of data points and can be based upon the reflectance of a single area of print medium 24 defined by an area of first side 24a of print medium 24 that is exposed to first side source light SL1 when print medium 24 is held in a stationary position during the reflectance determination. The first set of reflectance data can also be based upon the reflectance of a larger area of first side 24a of print medium 24 such as might be obtained by measuring reflectance of first side 24a over a period of time while print medium 24 is being moved. In the latter embodiment, the reflectance data can comprise a set of more than one reflectance measurements that indicate the reflectance of portions of first side 24a that that are illuminated by first side source light 24a during reflectance measurements. Alternatively, the first set of reflectance data can comprise an average, mean, or other overall measure of the reflectance that can be determined based upon statistical analysis of more than one reflectance measurement. In certain embodiments, first side light detector 48 can be adapted to detect light in a manner that averages the intensity of the first side reflected light over a period of time during which different portions of first side 24a of print medium 24 are exposed to first side source light SL1 and to generate a first side reflectance signal indicative of an average or overall reflectance of first side 48. As noted above, first side light detector 48 can be adapted to sense specular reflection, diffuse reflection, or both. Accordingly, the first set of reflectance data can be based upon sensed specular reflection, diffuse reflection or both.

FIG. 3 illustrates an example distribution of first side reflectance values of an image receiving side of a representative set of possible print medium types that could be used in a particular printer. In this example, the set of representative print mediums includes a first photo paper 100, a second photo paper 102, a third photo paper 104, a fourth photo paper 106, a fifth photo paper 108, a first plain paper 110, a second plain paper 112, a third plain paper 114, a fourth plain paper 116, a fifth plain paper 118, a first transparency 120 and a second transparency 122.

As can be seen from FIG. 3, it can be difficult to establish that a particular print medium is of a particular print medium type based upon the first side reflectance values because there are situations wherein the first side reflectance values for one print medium type are quite similar to the first side reflectance values of another print medium type. For example, in the example of FIG. 3, first side reflectance values for fifth photo paper 108, first transparency 120 and second transparency 122 are quite similar and fifth photo paper 108 could be mistakenly determined to be a transparency. Similarly, third plain paper 114 could mistakenly be determined to be a photo paper such as photo paper 102. Accordingly, there is a need to obtain additional data that can be used to allow better print medium type discrimination and to do so in a manner that is reliable, cost effective and efficient.

In the present invention, a second set of reflectance data is obtained from a second side 24b of print medium 24 (step 86) using second side reflectance sensor 44. In the embodiment of FIG. 1, processor 34 generates a second side illumination signal that causes second side light source 50 to radiate second side source light SL2 having a known intensity and/or wavelength at a time when print medium 24 is positioned in scanning area 78. Second side light detector 52 receives second side reflected light RL2, generates a second intensity signal which indicates indicating an intensity of second side reflected light RL2. The second intensity signal is received by processor 34. Processor 34 uses the second intensity signal to determine a second set of reflectance data. In one embodiment, the absolute value of the second intensity signal or an intensity of the second side reflected light RL2 determined therefrom is used to form the second set of reflectance data. In other embodiments, the intensity of the second side reflected light RL2 indicated by the second intensity signal is compared to a known intensity or range of intensities of second side source light SL2 to determine the second set of reflectance data.

The second set of reflectance data can comprise a single data point or a plurality of data points and can be based upon the reflectance of a single area of print medium 24 defined by an area of second side 24b of print medium 24 that is exposed to second side source light SL2 when print medium 24 is held in a stationary position during the reflectance determination. The second set of reflectance data can also be based upon the reflectance of a larger area of second side 24b of print medium 24 such as might be obtained by measuring reflectance of second side 24b mover a period of time when print medium 24 is being moved. In the latter embodiment, the second set of reflectance data can comprise a set of more than one reflectance measurements that indicate the reflectance of portions of second side 24b that are illuminated by second side source light SL2 during reflectance measurements. Alternatively, the second set of reflectance data can comprise an average, mean, or other overall measure of second side reflected light RL2 that can be determined based upon statistical analysis of more than one reflectance measurement. In certain embodiments, second side light detector 52 can be adapted to detect light in a manner that averages the intensity of second side reflected light RL2 over a period of time during which different portions of second side 24b of print medium 24 are exposed to second side source light SL2 and to generate a second side reflectance signal indicative of an average or overall reflectance of second side 24b.

As noted above, second side light detector 52 can be adapted to sense specular reflection, diffuse reflection or both, accordingly the first set of reflectance data can be based upon sensed specular reflection, diffuse reflection or both.

FIG. 4 shows a side by side comparison of the first side reflectance and second side reflectance of the hypothetical set of print medium types of FIG. 3. As can be seen from FIG. 4, there are variations in the second side reflectance measures that can be used to help discriminate between print mediums. In one embodiment, first set of reflectance data and second set of reflectance data are then compared (step 88) and print medium 24 is assigned to one of a plurality of print categories based upon the comparison of the first set of reflectance data and the second set of reflectance data.

In step 88 a first side/second side reflectance comparison is used to associate a print medium with, for example, one of at least two categories of print mediums, with each category including only a subset of the possible types of print mediums that can be used in printer 20. This categorization can be made by determining a difference between first side reflectance values and second side reflectance values for each of the print mediums in the set of representative print mediums and establishing a first/second side reflectance differential threshold that can be used to categorize the print medium types.

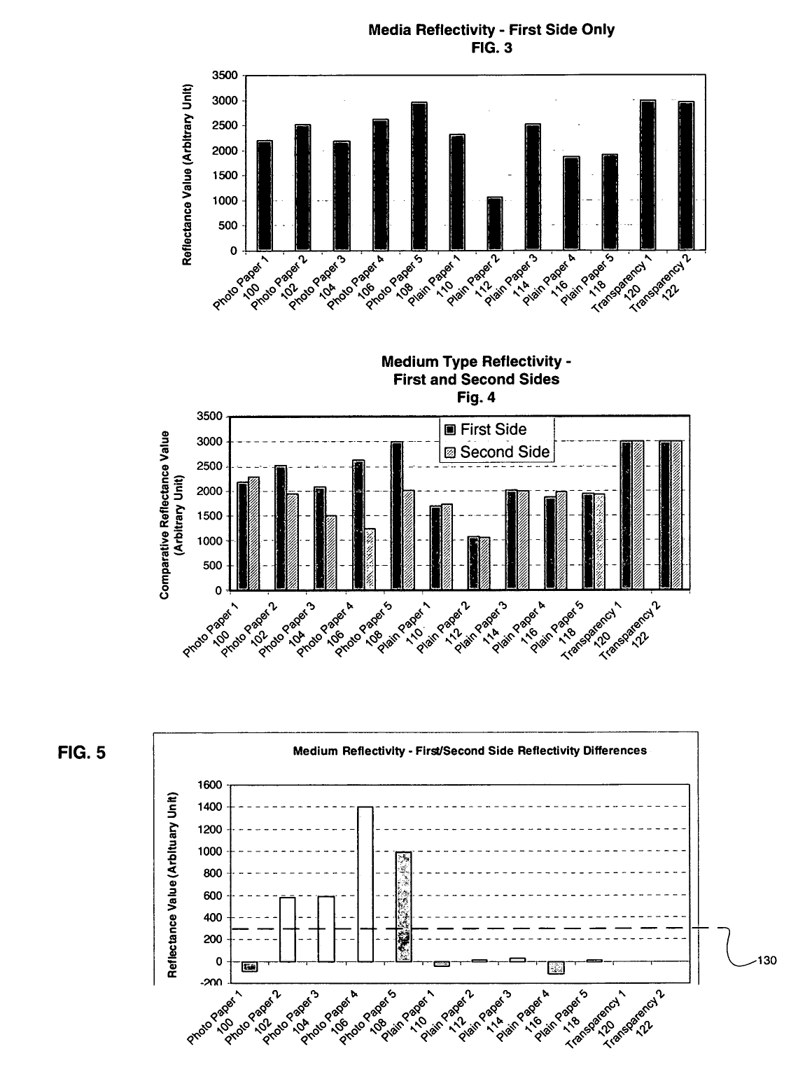

As can be seen from FIGS. 4 and 5, plain papers 110-118 each have a relatively high second side reflectance value and because these relatively high second side reflectance values are subtracted from first side reflectance values that are somewhat lower in general than the first side reflectance values of the photo papers, the differential reflectance values of the plain papers shown in FIG. 5 are generally much lower than the differential reflectance values of either of the photo papers 102-108. This allows, generally, a threshold to be determined to segregate plain papers and photo papers into a low differential reflectance category and a high- differential reflectance categories.

Similarly, because transparencies 120 and 122 typically have a first side reflectance and a second side reflectance that are quite similar, the differential reflectance values are typically low and thus transparencies 120 and 122 can be separated into the low differential reflectance category with the plain papers also using threshold 130.

Accordingly, as shown in FIG. 4, processor 34 can use a threshold, 130 to identify with an acceptable degree of precision whether a print medium 24 is in a category that generally includes transparencies and plain paper or in a category that generally includes photo papers. This information can be used by processor 34 to in printing operations.

This categorization also greatly facilitates the optional step (step 92) of making a further determination as to the type of medium by limiting the number of print medium types that must be considered when determining a medium type for a particular medium so that discrimination between medium types can be accomplished. Within each category, discrimination can be made on the basis of first side reflectance values and, optionally, second side reflectance values or combined reflectance values can be used to provide greater discrimination of medium type within a category.

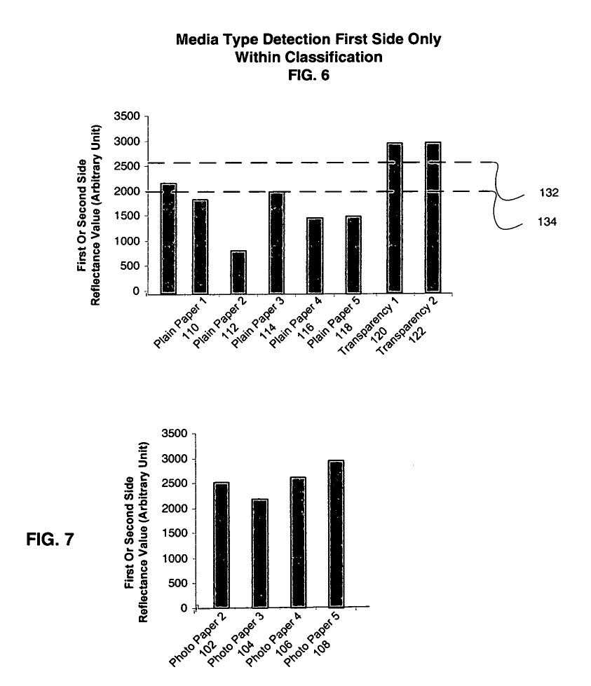

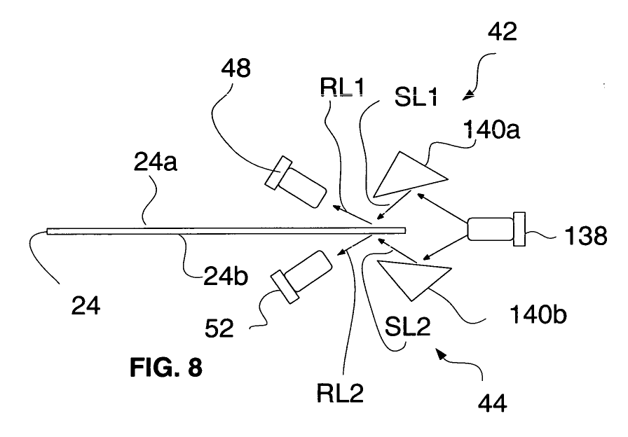

For example, as shown in FIG. 6, there is little overlap of first side reflectance values within the category of low combined reflectance medium types. Similarly, as shown in FIG. 7, there is little overlap of first side reflectance values within the category of high combined reflectance medium types.

Further, even where the potential for such overlap exists, comparison of differential reflectance values for such print mediums can be used to better discriminate between medium types. For example, as illustrated in FIG. 6, the fourth plain paper 116 and the fifth plain paper 118 have similar first side reflectance values, however, discrimination therebetween can be made based upon the differential reflectance values shown in FIG. 5. For example, as shown in FIG. 6, once that it is known that a print medium 24 is in a low differential reflectance category discrimination between medium types with that category can be made for example by applying a print medium type detection threshold 132 to the first side reflectance data for the print mediums in that category. Further categorization between print medium types can be performed using one or more additional thresholds. An example of such an additional threshold is threshold 134 that separates photo paper 100 from plain papers 112-118. Or alternatively, additional categories can be established for such print mediums.

Specifically, in FIG. 6, a determined first side reflectance value of a print medium within the low differential reflectance category can be compared against first threshold 132 to determine if a print medium is a transparency 120 or 122 and additional threshold 134 can be used to determine whether the print medium is first photo paper 100. The value of first threshold 132 or additional threshold 134 can be in a range that is also associated with certain photo-papers. This would create uncertainty if such photo papers 102-108 had not been excluded from consideration as a possible print medium type. However, with these papers excluded from consideration, reliable discrimination becomes possible.

Once that a category has been determined for print medium 24 and optionally the type of the print medium has been determined, processor 34 can use this information regarding the category of a print medium 24 and/or type of a print medium 24 in the performance of at least one printing function (step 94). Examples of such a printing function include determining colors to be printed on print medium 24, determining a printing speed for printing using print medium 24, determining whether an image can be printed using print medium 24, determining whether there is a need to reload the a print medium supply 66, selecting a dye or colorant set for use in printing using print medium 24 or for other purposes related to printing an image. Other examples of such a printing function include determining before printing, whether printer 20 has been loaded with a desired type of print medium 24.

For example, a print medium 24 can be received that requests that a particular type of print medium 24 is to be used during the satisfaction of a particular print order. For example, a print order can request that an image is to be printed on a transparency and the reflectance values from of a print medium drawn from print medium source 76 can be obtained an compared to verify that the requested medium type is being used. Additionally, where the quality of the print medium is of importance, controller 34 is further adapted to use the reflectance data to determine whether the print medium is has a quality level required for a particular print medium. For example, a print medium 24 comprises a photo paper that is to be used to render a glossy print, the reflectance data can be obtained and analyzed in a manner that allows a determination of the evenness of the gloss to be made.

A further printing function can include determining whether a print medium 24 is loaded into printer 20 with a desired side positioned so that it can be printed on. For example, a glossy type photo paper will have one side that is treated to have a glossy surface texture. An image is to be recorded on this side. A comparison of a first side reflectance and a second side reflectance can be used to identify whether such a photo paper type is loaded with the proper side facing print engine 22 by detecting reflectance values that are the inverse of what is expected.

Where the print medium 24 in printer 20 does not comprise a proper print medium type, where the print medium 24 has been mis-loaded or where print medium 24 has an unacceptable level of quality, controller 34 can prevent printing until the problem is corrected and/or can cause a warning to be presented using for example display 39.

Other types of comparison can be used to compare the first set of reflectance data to the second set of reflectance data. For example, the ratio of specular and diffuse reflectance can be used as a measure of reflectance and compared in similar fashion. Alternatively, the standard deviation of either specular or diffuse reflectance over a wide area can be used as a measure of reflectance of a side of print medium 24 and compared, or the ratio of reflectance between two or more different light sources (either optical properties or orientation) can be compared in like fashion.

Further, it will be appreciated that, in the embodiment of FIG. 1, first side reflectance sensor 42 and second side reflectance sensor 44 each have an individual and separate light source and light detector. In other embodiments of the invention, common components can be used for radiating source light or for detecting reflected light. For example, arrangement of mirrors, optical fibers, light pipes or other structures well known to one of ordinary skill in the art can be provided that direct source light from a common source to both first side 24a and second side 24b of print medium 24.

FIG. 8 illustrates one possible arrangement of a reflectance sensor of this type comprising an embodiment of first side reflectance sensor 42 and second side reflectance sensor 44 wherein a common light source 138 provides light to both of a first side reflecting mirror 140a and a second side reflecting mirror 140b which in turn direct a portion of this light as first side source light SL1 onto first side 24a and a portion of this light as second side source light SL2 onto second side 24b respectively of receiver medium 24. First side light detector 48 and second side light detector 52 senses first side reflected light RL1 and second side reflected light RL2.

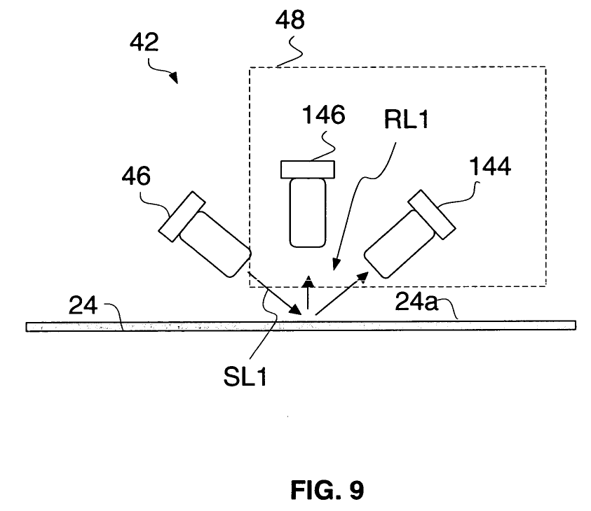

FIG. 9 also shows another arrangement of a reflectance sensor such as first side reflectance sensor 42 of the invention. In this embodiment, first side reflectance sensor 42 has a first side light detector 48 that is adapted to detect specular reflectance and diffuse reflectance. In this regard, a first side light source 46 applies first side source light SL1 to a first side 24a of medium 24 and a portion of first side reflected light RL1 is reflected by first side 24a of medium 24 in a specular fashion to a first side specular reflectance sensor 144 while another portion of first side reflected light RL1 is reflected in a diffuse fashion to a first side diffuse reflectance sensor 146. As a shown in the embodiment of FIG. 9, first side specular reflectance sensor 144 is positioned relative to medium 24 at an angle that is equal to an angle of incidence of first side source light SL1. As is also shown in the embodiment of FIG. 9, first side diffuse reflectance sensor 146 is positioned relative to medium 24 at a position wherein first side diffuse reflectance sensor 146 will receive a portion of source light SL1 that is reflected by medium 24 at an angle that is other than an angle that is equal to be angle of incidence of source light SL1.

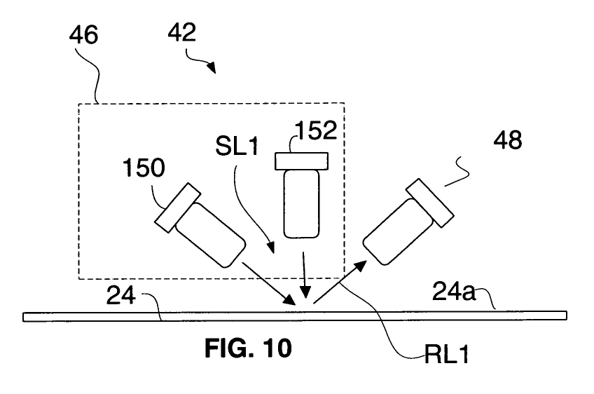

FIG. 10 shows another embodiment of a reflectance sensor such as first side reflectance sensor 42. In this embodiment, first side reflectance sensor 42 is adapted to sense the diffuse reflectance and the specular reflectance of first side 24a of print medium 24 using a single first side light detector 48. As can be seen in this embodiment, a first side light source 46 has a light source 150 is provided that applies a portion of source light SL1 to first side 24a of print medium 24 at an angle of incidence that is equal to an angle at which first side light detector 48 is arranged relative to first side 24a of print medium 24, and an additional light source 152 that is arranged relative to first side 24a, to apply an additional portion of source light SL1 at an angle of incidence that is not equal to the angle at which first side light detector 48 is arranged relative to first side 24a. Accordingly, first side reflected light RL1 comprises light from both sources and thus is indicative of both the specular and diffuse reflectance of first side 24a. It will be appreciated that a similar structure can be used, as desired, to provide a second side reflectance sensor 44 that senses the diffuse and specular reflectance of second side 24b of print medium 24.

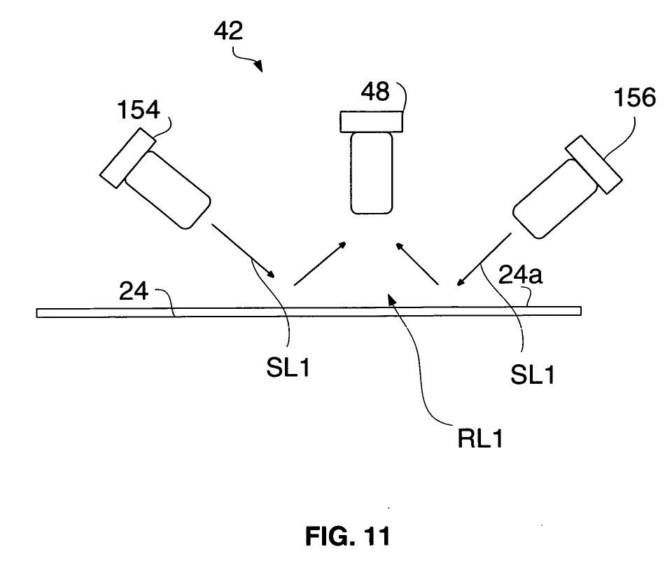

FIG. 11 shows still another embodiment of a reflectance sensor such as first side reflectance sensor 42 useful in the present invention. In this embodiment, first side reflectance sensor 42 is adapted to sense the diffuse reflectance of first side 24a using a single first side light detector 48 and at least two sources of light. As can be seen in this embodiment, a first side light source 154 is provided that applies a portion of source light SL1 to first side 24a of print medium 24 at an angle of incidence that is different from an angle at which first side light detector 48 is arranged relative to print medium 24a, and an additional first side light source 156 is arranged relative to print medium 24a, to apply further portion of source light SL1 to light print medium 24a at an angle of incidence is different from the angle at which first side light detector 48 is arranged relative to medium 24a. This allows a first side light detector 48 to be used determine diffuse reflectance of first side 24a of print medium 24 at more than one point on surface 24a without moving print medium 24. It will be appreciated that a similar structure can be used, as desired, to sense the diffuse and specular reflectance of second surface 24b of print medium 24.

The invention has been described in detail with particular reference to certain preferred embodiments thereof, but it will be understood that variations and modifications can be effected within the spirit and scope of the invention.

### Parts List

20 printer
21 housing
22 print engine
24 print medium
24a first side of print medium
24b second side of print medium
26 medium advance
27 printing area
28 motor
30 pinch roller
32 image capture system
34 processor
36 user input system
37 keypad
38 mouse
39 display
40 sensors
42 first side reflectance sensor
44 second side reflectance sensor
46 first side light source
48 first side light detector
50 second side light source
52 second side light detector
60 memory
62 hard drive
64 disk drive
66 memory card slot
68 removable memory
70 removable memory interface
72 remote memory system
74 communication system
76 print medium storage area
78 scanning area
80 receive print order step
82 load print medium step
84 obtain first side reflectance step
86 obtain second side reflectance step
88 compare step
92 determine type step
94 perform print function step
100 first photo paper
102 second photo paper
104 third photo paper
106 fourth photo paper
108 fifth photo paper
110 first plain paper
112 second plain paper
114 third plain paper
116 fourth plain paper
118 fifth plain paper
120 first transparency
122 second transparency
130 threshold
132 threshold
138 common light source
140a first side mirror
140b second side mirror
144 first side specular reflectance sensor
146 first side diffuse reflectance sensor
150 light source
152 additional light source
154 light source
156 additional light source
SL1 first side source light
RL1 first side reflected light
SL2 second side source light
RL2 second side reflected light

1. A method of determining a type of print medium in a printer, a method comprising the steps of:
obtaining a first set of reflectance data from a first side of the print medium;
obtaining a second set of reflectance data from a second side of the print medium;
comparing the first set of reflectance data to the second set of reflectance data; and
categorizing the print medium as being in one of a plurality of print medium categories based upon the comparison of the first set of reflectance data and second set of reflection data.

2. The method of claim 1, wherein at least one of the first set of reflectance data and the second set of reflectance data is based upon the specular reflectance of the print medium.

3. The method of claim 1, wherein at least one of the first set of reflectance data and the second set of reflectance data is based upon diffuse reflectance of the print medium.

4. The method of claim 1, wherein at least one of the first set of reflectance data and the second set of reflectance data is based upon a combination of the specular reflectance of the print medium and diffuse reflectance of the print medium.

5. The method of claim 1, wherein at least the first set of reflectance data or the second set of reflectance data comprise reflectance data that is based upon reflectance measurements from more than one portion of the print medium, the standard deviation of either specular or diffuse reflectance over a wide area of the print medium, the ratio of specular and diffuse reflectance, or the ratio of reflectance between two or more different light sources.

6. The method of claim 1, further comprising the step of performing at least one printing function based upon the determined category of the print medium.

7. The method of claim 1, wherein said comparing comprises the steps of a determining differential reflectance data representing a difference between the first set of reflectance data and the second set of reflectance data, and comparing the different reflectance data against a first predetermined threshold value to determine if the print medium is in a first differential reflectance category or a second differential reflectance category.

8. The method of claim 1, further comprising the step of determining a print medium type within a set of print medium types associated with the determined print category based at least in part upon the differential reflectance.

9. The method of claim 1, wherein the first set of reflectance data is based upon light reflected by the receiver medium said light being supplied by a LED, a laser, a laser diode, a monochromatic light source, or a polychromatic light source.

10. The method of claim 1, wherein second reflectance data is based upon light reflected by the receiver medium, said light being supplied by an LED, a laser, a laser diode, a monochromatic light source, or a polychromatic light source.

11. The method of claim 1, further comprising the step of determining specific medium type within a print medium category based on the first set of reflectance data or second set of reflectance data.

12. The method of claim 1, wherein the plurality of print medium types comprises at least one of a receiver medium, a photo paper, a non-photo paper, a glossy paper, a matte paper, a transparency, a fabric, a film, a ceramic product, a wood product, a metal or a glass.

13. A printer comprising:
a medium transport for conveying a print medium from a supply to a printing area
a printhead at the print area for forming an image using a print medium:
a first reflectance sensor positioned in the medium transport path to confront the print medium before the print medium is conveyed to the print area, said first reflectance sensor having a first light source adapted to supply light to a first side of the print medium and a first detector adapted to generate a first reflectance signal that is indicative of an amount of the supplied light that is reflectively returned to the first detector;
a second reflectance sensor positioned in the medium transport path to confront the print medium before the print medium is conveyed to the print area, said first reflectance sensor having a second light source adapted to supply light to a second side of the print medium and a second detector adapted to generate a second reflectance signal that is indicative of an amount of the supplied light that is reflectively returned to the second detector; and
a controller for causing the medium transport to transport the print medium to the printing area, for causing the first light source to supply light to the first side of the print medium and to detect the amount of the supplied light that is reflectively returned thereto, for causing the second light source to supply light to the second side of the print medium and to detect the amount of the supplied light that is reflectively returned thereto;
said controller further being adapted to receive the first reflectance signal and the second reflectance signal and to determine a category for the print medium from a plurality of categories based upon a comparison of the reflectance of the first side of the print medium and the second side of the print medium as indicated by the first reflectance signal and the second reflectance signal.

14. The printer of claim 13, wherein at least one of the first light source and second light source comprises a light emitting diode, a laser, a laser light emitting diode, a monochromatic light source, and a polychromatic light source.

15. The printer of claim 14, wherein at least one of the first detector and second detector are adapted to sense at least one of specular reflectance and diffuse reflection.

16. The printer of claim 13, wherein said processor is adapted to determine a category for the print medium based upon a difference between a first side reflectance as indicated by the first side reflectance signal and a second side reflectance as indicated by the second side reflectance signal.

17. The printer of claim 13, wherein said printhead is adapted to form images using a set of print medium types and wherein each category is associated with a subset of the set of print medium types.

18. The printer of claim 17, wherein said processor is forth adapted to determine a print medium type from among the print medium types within the category of a print medium based upon the first reflectance signal and second reflectance signal.

19. The printer of claim 13, wherein the controller is further adapted to determine whether the print medium has been loaded with a preferred side positioned to receive an image during printing.

20. The printer of claim 13, wherein the controller is adapted to determine whether the print medium is of a print medium type that the controller has been requested to use during a print job.

21. The printer of claim 13, wherein the controller is further adapted to use the reflectance data to determine whether the print medium is has a quality level required for a particular print medium.

22. A printer comprising:
a medium transport for moving a print medium through a medium transport path to a printing area;
a first light source and first detector positioned on a first side of the medium transport path for collecting a first set of reflectance data from a first side of the print medium; and
a second light source and a second detector positioned on a second side of the medium transport path for collecting a second set of reflectance data from a second side of the print medium;
wherein a controller causes the first and second sets of reflectance data to be collected prior to a point where a print medium in the print medium transport path is moved to the printing area.

23. The printer of claim 22, wherein at least one of the first detector and second detector are adapted to sense at least one of specular reflectance and diffuse reflection.

24. The printer of claim 22, wherein the controller is further adapted to determine a category for the print medium from a plurality of categories based upon a comparison of the first set of reflectance data and the second set or reflectance data.

25. The printer of claim 23, wherein least one of the first light sensor and second light sensor has two or more light sources with a common detector, wherein the lights sources have different optical properties such as emitting wavelength from each other.

26. The printer of claim 23, wherein at least one of the first light sensor and second light sensor contains two or more light sources with a common detector, wherein the lights sources have different orientations relative to the print medium and each other media.
